(19) United States
(12) Patent Application Publication
(10) Pub. No.: US 2005/0044029 A1
(43) Pub. Date: Feb. 24, 2005

(54) Hybrid securities having protection against event risk using uncorrelated last-to-default baskets

(75) Inventors: Richard L. Griffin, San Francisco, CA (US); Lior Evan, Forest Hills, NY (US)

Correspondence Address: NIXON & VANDERHYE, PC, 1100 N GLEBE ROAD, 8TH FLOOR, ARLINGTON, VA, 22201-4714, US

(73) Assignee: Babcock & Brown LP, a Delaware limited partnership, San Francisco, CA (US)

(21) Appl. No.: 10/805,475

(22) Filed: Mar. 22, 2004

Related U.S. Application Data
(60) Provisional application No. 60/461,822, filed on Apr. 11, 2003.

(51) Int. Cl. G06F 17/60

(52) U.S. Cl. 705/36; 705/37

(57) ABSTRACT

Hybrid securities defined as last-to-default credit default swaps over multiple name baskets and having protection against event risk. In the preferred embodiment, the hybrid security is defined as a second-to-default credit default swap over a two-name basket, wherein the underlying reference obligors in the basket are uncorrelated or substantially uncorrelated. A portfolio of second-to-default swaps over two-name baskets is provided, wherein the portfolio is defined in a manner that further reduces default risk through enhanced diversification achieved by recombining underlying reference obligors in different second-to-default baskets. A structured investment in a portfolio of underlying second-to-default swaps over two-name baskets is provided using a collateralized debt obligation (CDO) structure.

### RELATED APPLICATIONS

This application claims priority on U.S. Provisional Application Ser. No. 60/461,822 filed Apr. 11, 2003, the entire content of which is incorporated by reference herein.

### FIELD OF THE INVENTION

The instant invention relates to investments in credit markets and, more particularly, to new and improved securities and the like that provide protection against event risk. The instant invention provides a unique new class of assets that enable substantially reduced risk of default or other defined credit events resulting from unexpected events. The hybrid securities of the invention are defined as last-to-default credit default swaps over multiple name baskets. In the preferred embodiment, a hybrid security of the invention is defined as a second-to-default credit default swap over a two-name basket, wherein the underlying reference obligors in the basket are uncorrelated or substantially uncorrelated. The invention also provides a portfolio of such second-to-default swaps over two-name baskets, wherein the portfolio is defined in a manner that further reduces default risk through enhanced diversification achieved by recombining underlying reference obligors in different second-to-default baskets. The invention further provides a structured investment in a portfolio of underlying second-to-default swaps over two-name baskets using a collateralized debt obligation (CDO) structure.

### BACKGROUND AND SUMMARY OF THE INVENTION

Investors are constantly looking for new and improved investment opportunities that provide suitable benefits for an acceptable risk, and that preferably operate to further diversify an existing portfolio. One class of investors is credit investors, i.e., investors that invest in credit markets. Credit investors buy credit exposure, such as bonds, credit derivatives and/or any other known type of credit related instruments. Various sources of information are available to credit investors that can be used to assist such investors in assessing the risks of a particular investment. For example, performance ratings on bonds and other credit related instruments are provided by ratings agencies, such as S&P and Moody's. These credit ratings are based on historical data and predictable information. Such credit ratings, however, are incapable of accounting for event risk due to the unexpected and unpredictable nature of such risk. Event risk, such as fraud, terrorism etc., that are unrelated to the underlying asset(s) of a reference obligor cannot be predicted and, therefore, cannot be accurately accounted for in performance ratings. Even highly rated credit instruments can suddenly suffer serious losses through default or other defined credit events as a result of unexpected events. Thus, event risk represents an unknown and potentially devastating risk for investors.

The unpredictable nature and the impact of even risk can be seen in FIG. 1, which shows Moody's historical versus idealized default curves for the various bond rating categories using a cumulative five year default rate. As can be seen in FIG. 1, the actual performance of higher rated bonds (Aaa to Aa2) materially lags idealized performance. Due to the unpredictable nature of event risk, it is not possible for ratings agencies to properly reflect future event risk in its ratings. The default rate difference between the historical and the idealized default curves of FIG. 1 represents the event risk spread and illustrates the impact of event risk on default rates.

The inherent unpredictability and unexpected nature of event risk can wreak havoc on credit investors (e.g., bond investors), including those with diversified portfolios. The past two to three years have highlighted the importance of protecting against event risk. For example, Enron had a Baa1/BBB+ rating just five weeks prior to default. WorldCom had a A3/A− rating just five months prior to default. Finova had a Baa1/A− rating just 12 months prior to default. Additionally, National Century Financial Enterprises recently issued a structured CDO with AAA and other highly rated classes that is now in default. The 9/11 tragedy resulted in two major airline bankruptcies (USAir, UAL), with perhaps others to follow. Unexpected events caused these investments to default without any significant advance warning to investors. These examples represent only a small fraction of the investments that have been seriously impacted by event risk in recent years.

Investors traditionally use subordination and diversification in order to mitigate against default risk. Subordination can be achieved through, for example, a collateralized debt obligation (CDO) structure having various tranches. By assuring that tranches exist below an investor in the CDO structure, the investor has subordination that provides some protection for the investment. Diversification, on the other hand, is achieved by investing in many different bonds and/or other instruments, instead of just one, for example. While traditional subordination and diversification can provide some protection from default risk, a need exists for further protection from default and event risk. In addition, investment banks and the like are constantly looking for ways to hedge a large book of assets, in order to have insurance against a catastrophic event.

The instant invention addresses these needs by providing a new and improved asset class that has significant benefits as compared to traditional asset classes with respect to reduced risk of default or other defined credit events resulting from unexpected events (event risk). The hybrid securities of the invention are defined as last-to-default credit default swaps over multiple name baskets (i.e., ith to default of i). In the preferred embodiment, the hybrid security of the invention is defined as a second-to-default credit default swap over a two-name basket, wherein the underlying reference obligors in the basket are uncorrelated or substantially uncorrelated. As one skilled in the art understands, correlation values can range from 1 to −1, wherein 1 represents the highest positive correlation and −1 represents the highest negative correlation. The term uncorrelated as used herein means that the correlation (asset and/or default) between the reference obligors in the basket is within the range of slightly above zero to negative one (−1). The term substantially uncorrelated as used herein means that the underlying reference obligors in the basket have a correlation within the range of between about 0.5 to slightly above zero.

In accordance with the invention a portfolio of second-to-default swaps over two name baskets is constructed, wherein the reference obligors in each basket are uncorrelated or at least substantially uncorrelated. The portfolio is defined in a manner that further reduces default risk through enhanced diversification achieved by recombining underlying reference obligors in different second-to-default baskets. The second to default aspect of the securities of the invention provide significant default risk mitigation compared to traditional methods using subordination and diversification. The joint default requirement for the two-name basket gives the security of the invention protection against event risk. Thus, the securities of the invention are referred to as a Protection Against Event Risk Securities or PAERS. The invention further provides a structured investment in a portfolio of underlying second-to-default swaps over two-name baskets (PAERS) using a collateralized debt obligation (CDO) structure.

PAERS represents a unique new class of assets. PAERS provide substantially reduced risk of default or other defined credit events from unexpected events. The second to default nature of PAERS means that an unexpected event that causes a default in any single credit does not cause a default in the PAERS portfolio. The PAERS portfolio can have better quantitative credit characteristics than a portfolio of AAA credits, along with the additional qualitative benefit of protection against event risk. The PAERS structure enables investors to hedge increased exposure to individual credits without having to hedge a credit under distress. The PAERS portfolio performs very differently from a portfolio of its underlying credits, thereby achieving greater diversification benefits. No other known assets replicate the characteristics of PAERS.

The invention provides a new asset class that can be put into a CDO. In accordance with one aspect of the invention, a party, such as the assignee of the instant application, structures an overall PAERS transaction and arranges the various required elements. This includes working with a swap counterparty to build the portfolio of underlying swaps, modeling the PAERS portfolio to demonstrate the credit profile of the PAERS, arranging third party financial guarantee or PAERS Supersenior, if applicable, sourcing the PAERS equity, mezzanine and senior investors, as applicable, and obtaining debt ratings for the PAERS senior tranche and the underlying PAERS portfolio, if applicable. The party structuring the transaction could purchase some of the PAERS equity, if desired.

The instant inventors have modeled an exemplary portfolio of forty PAERS and found that the default distributions are significantly better as compared to a portfolio of unpaired reference obligors. PAERS also provides significant benefits as compared to other known basket default structures. As explained in detail below, the probability of two defaults occurring in a portfolio of two credits is significantly lower than the probability of two defaults occurring in a large portfolio. For example, assuming a 2.5% probability of individual default, the probability that both underlying credits in a PAERS defaults is 13.56 times better than the probability of default of two underlying credits in a six credit basket. Thus, the default characteristics of PAERS are material different and better than typical ith to default baskets.

In accordance with the invention, PAERS also provides improved hedging characteristics as compared to typical ith to default baskets. For example, upon default of or distress in one reference obligor, the PAERS investor can hedge its exposure by hedging the counterpart reference obligor through the liquid single name credit default swap market. Because of the low or non-correlation between the paired reference obligors, such a hedge is unlikely to be at a time of distress for that counterpart, and therefore cheaper to obtain. In a typical ith-to-default basket (say 2nd of 6), once an individual default occurs, the investor's risk increases as with PAERS. However, in order to hedge that increased risk, the non-PAERS investor must purchase a basket default swap (1st of 5). Such basket default swaps are significantly less liquid than single name swaps. They are also expensive because typical baskets comprise correlated names. In addition, the desired basket default swap might only be available from the original counterparty to the six-name basket. Thus, the hybrid securities of the instant invention have significant benefits from a hedging perspective over typical basket structures.

A PAERS portfolio also provides investors with significant benefits relative to a portfolio of individual credits. For example, a PAERS portfolio provides an “early warning” hedging ability for investors concerned about deterioration of particular credits in the portfolio. In a portfolio of individual credits, deterioration in the quality of any name raises the risk to the investor. In order to hedge that individual credit, the investor is likely to have to do so at a time of distress to that credit. In contrast, in a PAERS portfolio, deterioration of an individual name can be hedged by hedging its paired counterpart reference obligor, and not the reference obligor under distress. Similarly, if each underlying pair of reference obligors is viewed as a single security, increased risk of that security (including as a result of a default of one of the reference obligors) can be hedged by hedging the counterpart reference obligor. Because of the low or non-correlation between the paired reference obligors, such a hedge is unlikely to be at a time of distress for that counterpart. Thus, a hedge for a PAERS security should be much cheaper to obtain as compared to a hedge on a single-name security. This hedge can be readily obtained after the unexpected event that caused a deterioration in the credit quality of the portfolio.

The PAERS portfolio also provides investors with other significant benefits relative to a portfolio of individual credits. The PAERS portfolio can have better quantitative credit characteristics than a portfolio of AAA credits, along with the additional qualitative benefit of protection against event risk. Unpredictable events can result in defaults in a portfolio of individual credits. PAERS substantially mitigates against this risk, because any single event is highly unlikely to cause a PAERS default because of the low or non-correlation of the paired reference obligors.

The hybrid securities of the instant invention add diversification to an overall portfolio. In fact, an advantage of PAERS is that each security is inherently diversified and diversified against event risk as a result of the requirement for joint default of two (or more) uncorrelated or substantially uncorrelated asset. A PAERS portfolio performs very differently from a portfolio of its underlying credits, thereby achieving greater diversification benefits. Each pair is a unique new security, thereby enabling maximum diversification for a given set of underlying reference obligors. The invention may also provide advantages with respect to diversity scoring from ratings agencies due to the hybrid nature of the securities.

In accordance with the invention, an investment in a PAERS portfolio can be structured under, for example, standard ISDA credit default swap terms. To this end, the instant inventors have created a sample portfolio of forty PAERS swaps. In this sample PAERS portfolio each swap has a notional principal of $25 million and each swap has two underlying reference obligors, wherein no two swaps have the same pairing of reference obligors. Pursuant to each swap, the PAERS issuer (CDO vehicle) will receive a premium of X bps on the notional principal until maturity. A credit event of either reference obligor alone will not trigger termination or delivery under a swap, and the swap counterparty will continue to pay the premium to the PAERS issuer. Only a credit event of both reference obligors will result in a “basket credit event” for an individual Swap. Upon a basket credit event, premium payments on the individual swap will cease. The swap counterparty will then deliver to the PAERS issuer a “deliverable obligation” of the 2nd-to-default reference obligor with $25 million par value or, at the option of the PAERS issuer, the cash equivalent thereto. The PAERS issuer then delivers $25 million to the swap counterparty. The sample PAERS portfolio is described in greater detail below.

The total number of swaps in the portfolio and the notional principle can vary depending on the desires of the parties to the investment. In addition, the structure of the PAERS issuer (CDO vehicle) can vary and may include, for example, four tranches (supersenior, senior, mezzanine and equity) or more or fewer tranches. Some portion of the equity, mezzanine and/or senior tranches may be issued for cash. The supersenior tranche and any other unfunded tranche or portion thereof is issued in synthetic form through, for example, a standard ISDA credit default swap, referencing the PAERS portfolio and the relative position of the tranche. The invention is not limited to the use of conventional definitions for “default.” Instead, any defined credit event can be used in accordance with the invention to trigger “defaults” in a reference obligor. Defaults may be those defined by the ISDA, but any other suitable default condition(s) may be defined in the terms of the PAERS transaction agreement, in accordance with the instant invention.

In accordance with another aspect of the invention, the inventors have found that by repeating individual names in different pairings in the same notional size PAERS portfolio reduces overall risk. Increasing the number of PAERS with the total notional deal size remaining constant reduces the standard deviation of default risk due to enhanced diversification. Thus, it has been found that recombining underlying reference obligors in different 2^{nd}-to-default pairs also substantially reduces the standard deviation of default. As long as each pair has a low intra-pair correlation, duplication of a reference obligor with another counterparty is similar to adding to a bond portfolio another credit in the same industry to achieve diversification.

### BRIEF DESCRIPTION OF THE FIGURES

These and other objects, features and advantages of the invention will be apparent from the following detailed description of the invention when read in conjunction with the appended drawings, in which:

FIG. 1 is a graph showing historical and idealized default curves and illustrating the impact of event risk;

FIG. 2 is a graph comparing a default distribution for a group of unpaired reference obligors verses a group of Protection Against Event Risk Securities (PAERS) defined in accordance with a preferred embodiment of the instant invention;

FIG. 3 is a graph illustrating the benefit of the joint default aspect of PAERS;

FIG. 4 is a table showing twenty sample pairings for an exemplary PAERS portfolio, defined in accordance with a preferred embodiment of the instant invention;

FIG. 5 is a table of twenty second pairings for the exemplary portfolio of FIG. 4, defined in accordance with a preferred embodiment of the instant invention;

FIG. 6 is a table showing S&P asset correlation assumptions;

FIG. 7 is a table showing initial correlation assumptions used in defining the exemplary PAERS portfolio of FIG. 5;

FIG. 8 is a table comparing an exemplary PAERS portfolio default distribution with conventional hypothetical portfolios of uncorrelated AAA, uncorrelated AA+ and uncorrelated AA securities;

FIG. 9 is a table showing the exemplary PAERS portfolio cumulative default probability;

FIG. 10 is a table showing loss incidence distribution for a PAERS issuer in an exemplary CDO structure for an exemplary PAERS investment;

FIG. 11 is a graph showing results of a sensitivity analysis performed for an exemplary PAERS portfolio;

FIG. 12 is graph showing the cumulative default probabilities resulting from the sensitivity analysis shown in FIG. 11;

FIG. 13 is a chart summarizing the results of the sensitivity analysis shown in FIG. 12;

FIG. 14 is a graph illustrating the benefits achieved in a PAERS portfolio by increasing the number of PAERS by recombining reference obligors to reduce portfolio volatility, in accordance with a preferred aspect of the instant invention;

FIG. 15 is a structure diagram of an exemplary PAERS investment and illustrating issuance of PAERS equity;

FIG. 16 is a structure diagram illustrating the ongoing cash flow in the PAERS investment shown in FIG. 15;

FIG. 17 is a structure diagram illustrating the impact on the PAERS investment of FIG. 15 after the first default of a reference obligor;

FIG. 18 is a structure diagram illustrating the impact on the PAERS investment upon a first basket credit event;

FIG. 19 is a structure diagram illustrating the PAERS investment after the first basket credit event;

FIG. 20 shows structure diagrams illustrating the impact on the PAERS investment upon the third basket credit event and the flows after the thirds basket credit event;

FIG. 21 shows a structure diagram illustrating the PAERS investment of FIG. 15 at maturity with no defaults;

FIG. 22 is a graph showing the annual and cumulative probabilities of a BB− and BBB− bond over time;

FIG. 23 is a graph showing joint outcomes of independent assets (i.e., correlation=0) in an exemplary PAERS failure rates simulation;

FIG. 24 is a graph showing how an increase in the correlation value of the two assets represented in FIG. 23 affects the distribution of the joint outcomes;

FIGS. 25-26 are graphs illustrating the application of normal distribution to joint outcomes; and

FIG. 27 is a graph showing joint asset outcomes converted into default probability.

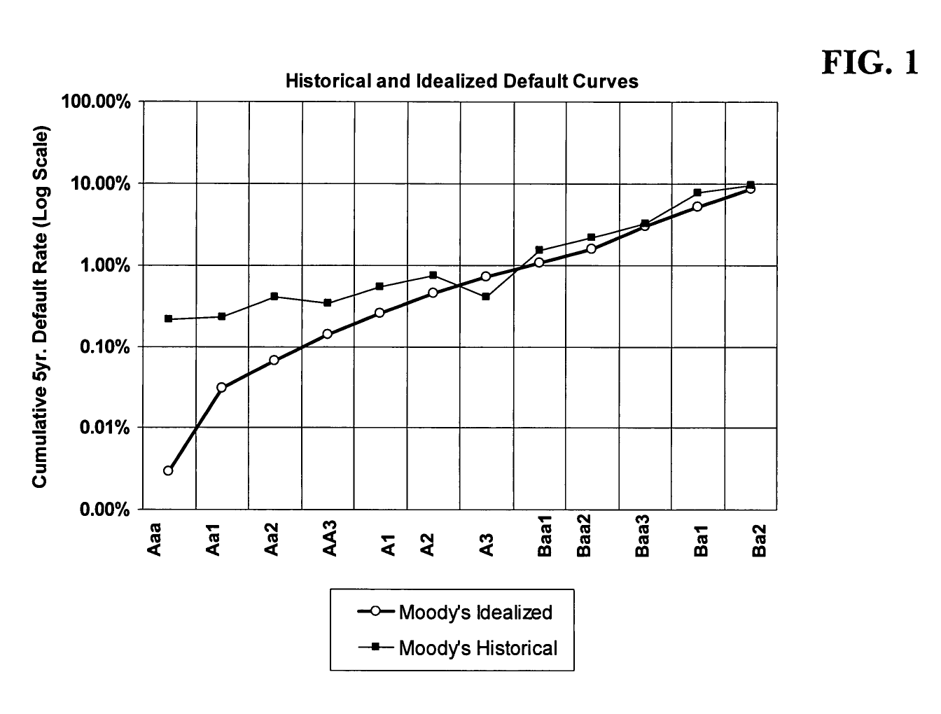

### DETAILED DESCRIPTION OF THE PREFERRED EMBODIMENTS

The instant invention provides a new and improved asset class that has significant benefits as compared to traditional asset classes with respect to reduced risk of default or other defined credit events resulting from event risk. The hybrid securities of the invention are defined, in their broadest sense, as last-to-default swaps over multiple name baskets (i.e., ith to default of i). In the preferred embodiment, the hybrid security of the invention is defined as a second-to-default credit default swap over a two-name basket, wherein the underlying reference obligors in the basket are uncorrelated or substantially uncorrelated. As explained below, the invention covers both individual hybrid securities (PAERS) created in accordance with the instant invention, as well as portfolios containing a plurality of underlying PAERS. The invention also covers CDO structures in which the PAERS portfolio is the asset class in the CDO.

Correlation values can range from 1 to −1, wherein 1 represents the highest positive correlation and −1 represents the highest negative correlation. The term uncorrelated as used herein means that the correlation (asset and/or default) between the reference obligors in the basket is within the range of slightly above zero to negative one (−1). The term substantially uncorrelated as used herein means that the underlying reference obligors in the basket have a correlation within the range of between about 0.5 to slightly above zero.

In accordance with the preferred embodiment of the invention, a portfolio of second-to-default swaps over two name baskets is constructed, wherein the reference obligors in each basket are uncorrelated or at least substantially uncorrelated. The portfolio is defined in a manner that further reduces default risk through enhanced diversification achieved by recombining underlying reference obligors in different second-to-default baskets. The joint default requirement for the two-name basket gives the security of the invention protection against event risk. PAERS provide substantially reduced risk of default or other defined credit events from unexpected events. The second to default nature of PAERS means that an unexpected event that causes a default in any single credit does not cause a default in the PAERS portfolio. The PAERS portfolio can have better quantitative credit characteristics than a portfolio of AAA credits, along with the additional qualitative benefit of protection against event risk. The PAERS structure enables investors to hedge increased exposure to individual credits without having to hedge a credit under distress.

An overall PAERS transaction can be arranged by, for example, working with a swap counterparty to build the portfolio of underlying swaps, modeling the PAERS portfolio to demonstrate the credit profile of the PAERS, arranging third party financial guarantee or PAERS Supersenior, if applicable, sourcing the PAERS equity, mezzanine and senior investors, as applicable, and obtaining debt ratings for the PAERS senior tranche and the underlying PAERS portfolio, if applicable.

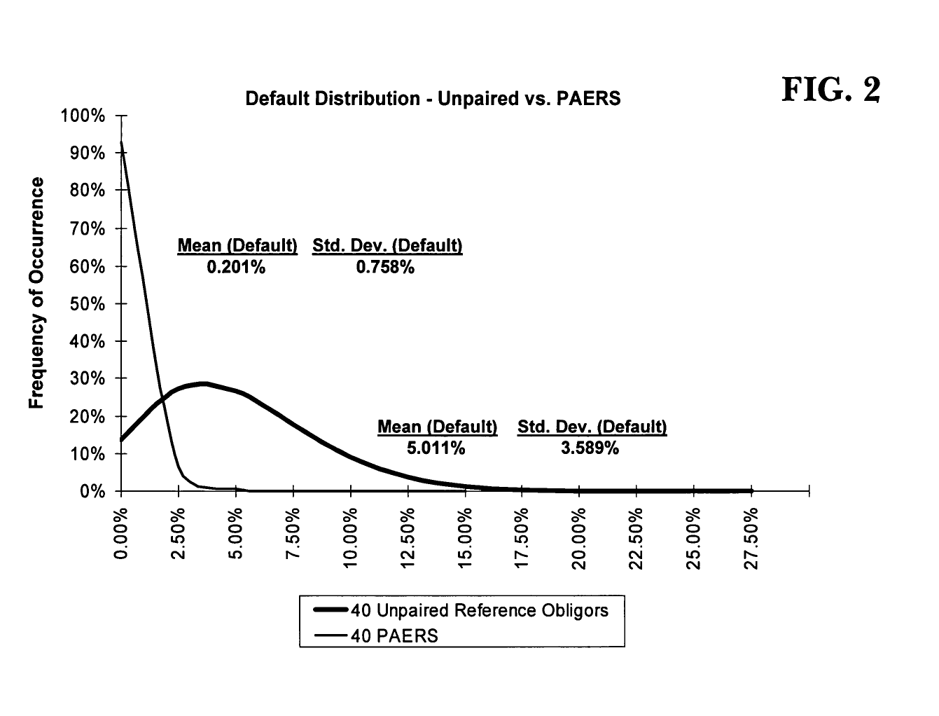

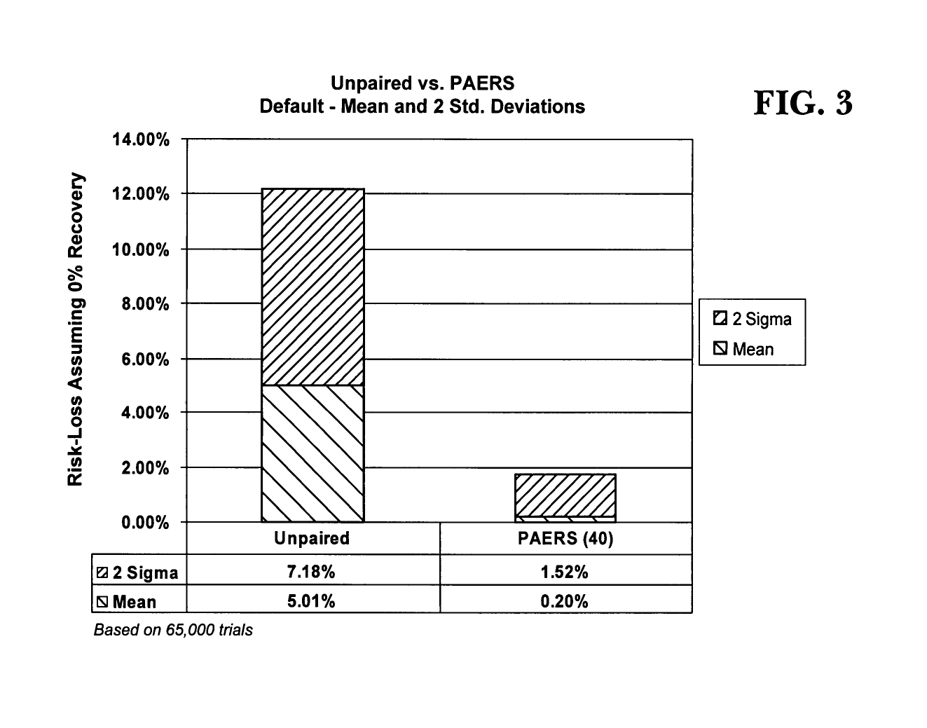

The instant inventors have modeled an exemplary portfolio of forty PAERS and found that the default distributions are significantly better as compared to a portfolio of unpaired reference obligors. The better default distribution of a PAERS portfolio as compared to a portfolio of unpaired securities can be seen in the graph of FIG. 2. FIG. 3 illustrates the benefits of joint default by comparing the default mean and 2 sigma for a PAERS and a nonpaired portfolio.

PAERS also provides significant benefits as compared to other known basket default structures. It is clear that the probability of 2 defaults occurring in a portfolio of 2 credits is significantly lower than the probability of 2 defaults occurring in a large portfolio. Mathematically (assuming no correlation and 2.50% probability of individual default), the probability of default of 2 underlying credits in a 6 credit basket can be determined as follows:
Combinations of 2 defaults in a 6 credit basket=15
The probability of any one combination of 2 defaults in a 6 credit basket=0.0005648
Therefore, the total probability of 2 defaults in a 6 credit basket=15×0.0005648=0.008472=0.8472%
The probability that both of 2 underlying credits in PAERS default is the probability of default of each credit multiplied by the other: 0.0250=0.0250=0.000625=0.0625% This is 13.56 times better than 2nd-to-default of 6. Thus, the probability that both underlying credits in a PAERS defaults is 13.56 times better than the probability of default of two underlying credits in a six credit basket. The formula for determining these probabilities is described in greater detail below.

In accordance with the invention, an investment in a PAERS portfolio can be structured under, for example, standard ISDA credit default swap terms. To this end, the instant inventors have created a sample portfolio of forty PAERS swaps. In this sample PAERS portfolio each swap has a notional principal of $25 million and each swap has two underlying reference obligors, wherein no two swaps have the same pairing of reference obligors. Pursuant to each swap, the PAERS issuer (CDO vehicle) will receive a premium of X bps on the notional principal until maturity. A credit event of either reference obligor alone will not trigger termination or delivery under a swap, and the swap counterparty will continue to pay the premium to the PAERS issuer. Only a credit event of both reference obligors will result in a “basket credit event” for an individual Swap. Upon a basket credit event, premium payments on the individual swap will cease. The swap counterparty will then deliver to the PAERS issuer a “deliverable obligation” of the 2nd-to-default reference obligor with $25 million par value or, at the option of the PAERS issuer, the cash equivalent thereto. The PAERS issuer then delivers $25 million to the swap counterparty. The sample PAERS portfolio is described in greater detail below.

The total number of swaps in the portfolio and the notional principle can vary depending on the desires of the parties to the investment. In addition, the structure of the PAERS issuer (CDO vehicle) can vary and may include, for example, four tranches (supersenior, senior, mezzanine and equity). For example, the PAERS issuer could issue four tranches as follows: 1) PAERS Supersenior having a size of 89.50%-93.25%, a notional of $895.0-$932.5 mm and credit support of 6.75%-10.50%; 2) PAERS Senior having a size of 3.50%-5.00%, a notional of $35.0-$50.0 mm and credit support of 3.25%-5.50%; 3) PAERS Mezzanine having a size of 2.00%-3.00%, a notional of $20.0-$30.0 mm and credit support of 1.25%-2.50%; and 4) PAERS Equity, having a size of 1.25%-2.50% and a notional of $12.5-$25.0 mm. Some portion of the equity, mezzanine and/or senior tranches may be issued for cash. The supersenior tranche and any other unfunded tranche or portion thereof is issued in synthetic form through, for example, a standard ISDA credit default swap, referencing the PAERS portfolio and the relative position of the tranche. The invention is not limited to the conventional definition for “default.” Instead, any defined credit event can be used in accordance with the invention to trigger “defaults” or “credit events” in a reference obligor. Defaults may be those defined by the ISDA, but any other suitable default condition(s) may be defined in the terms of the PAERS transaction agreement, in accordance with the instant invention.

As indicated above, a sample portfolio of PAERS has been constructed using 40 reference obligors. The reference obligors include 18 U.S. corporates, 16 foreign corporates, and 6 emerging market sovereigns. A 5 year standard ISDA credit default swap term was used for this example. In this sample portfolio, the average S&P rating for each of the reference obligors is BBB−/BB+. The reference obligors are paired as follows: each reference obligor is paired with an uncorrelated 2nd reference obligor; each reference obligor is included in two swaps, in each case with a different 2nd reference obligor; no reference obligor is paired with another reference obligor in the same industry or country; and no emerging market reference obligors are paired with each other. One or more of these sample rules can be changed depending on the particular transaction in which the invention is employed and the desires of the parties involved. Once the pairings are defined, S&P idealized default rate tables (from S&P's CDO Evaluator) and asset correlations in conjunction with a copula function are used to generate a loss distribution, mean, standard deviations and other statistical measures for the portfolio. Asset correlations between names and asset default probabilities are then preferably stress tested.

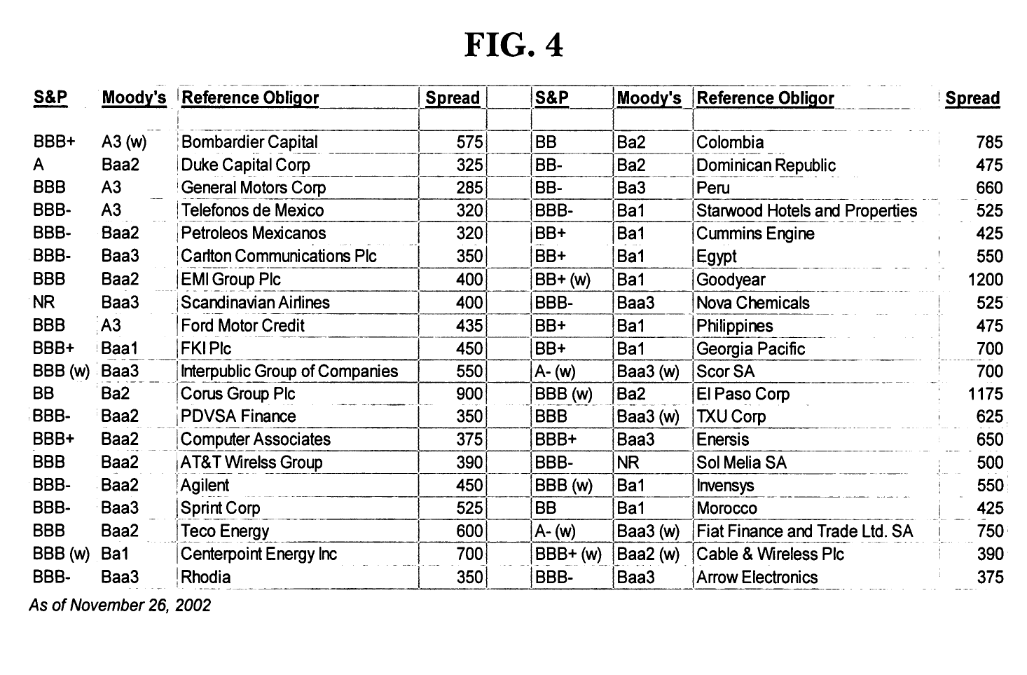

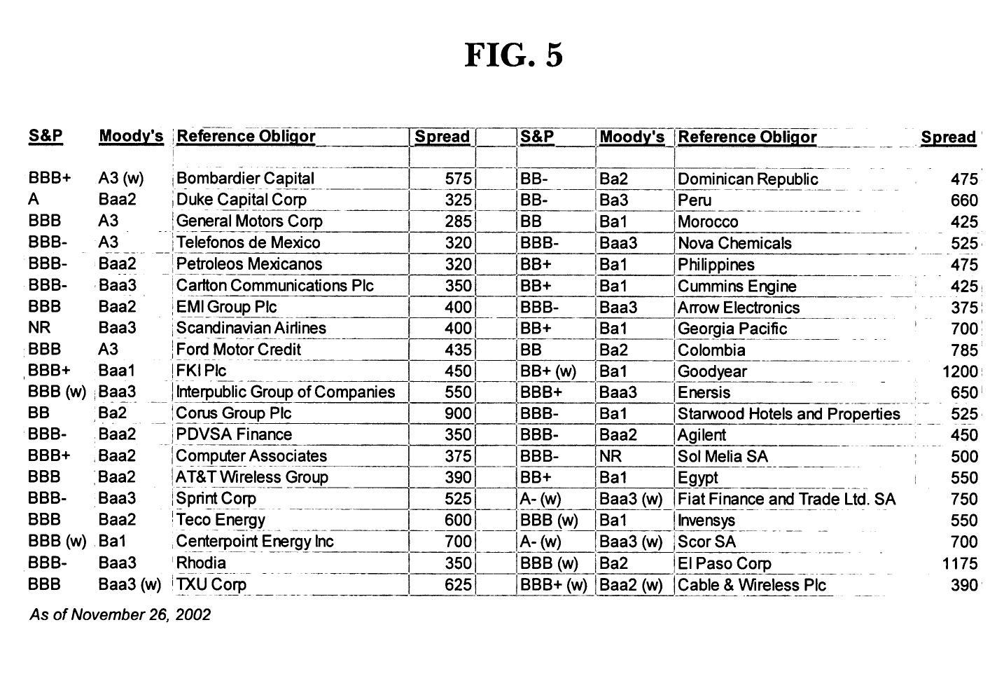

FIG. 4 shows a set of twenty sample pairings for the sample PAERS portfolio. As shown in FIG. 4, Bombardier Capital is paired with Columbia, thereby creating the new hybrid security of Bombardier-Columbia. The S&P and Moody's rating and the spreads for the individual reference obligors are also shown in FIG. 4. By pairing the forty reference obligors, a set of twenty hybrid securities are constructed in accordance with the instant invention. FIG. 5 shows a second set of twenty pairings constructed from the original forty reference obligors and using the sample rules described above. In this second set of pairings, Bombardier is paired with Dominican Republic, thereby creating the new hybrid security of Bombardier-Dominican. The combined set of the first and second pairings shown in FIGS. 4 and 5 define the sample portfolio of forty 2^{nd}-to-default baskets or swaps in accordance with the preferred embodiment of the invention.

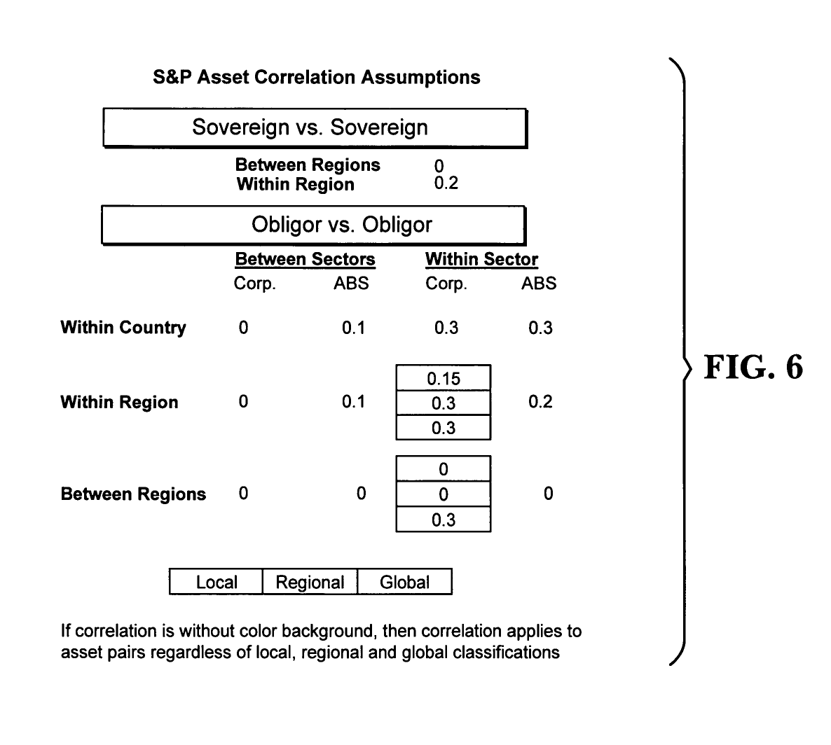

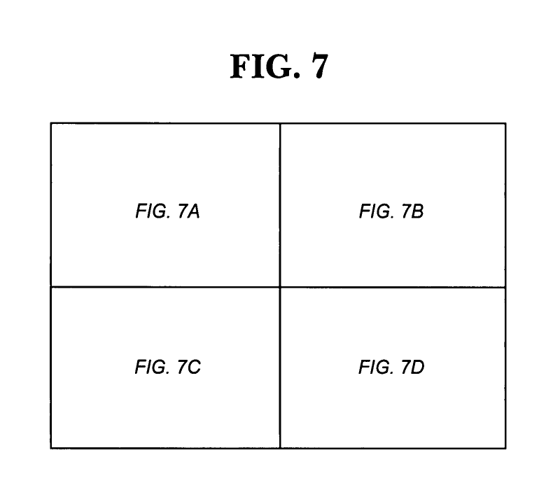

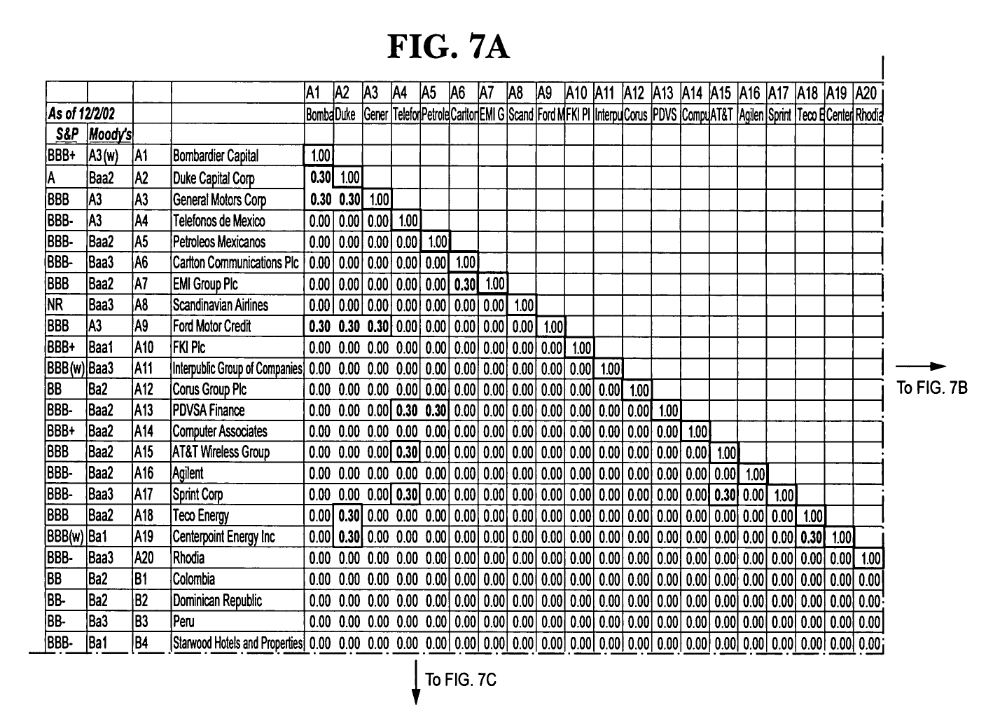

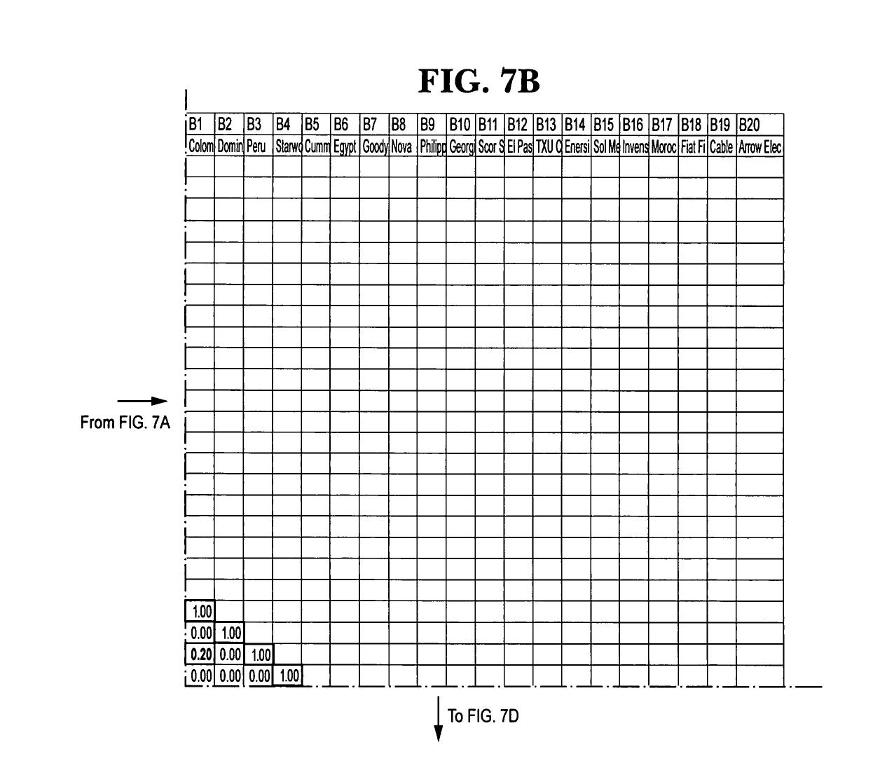

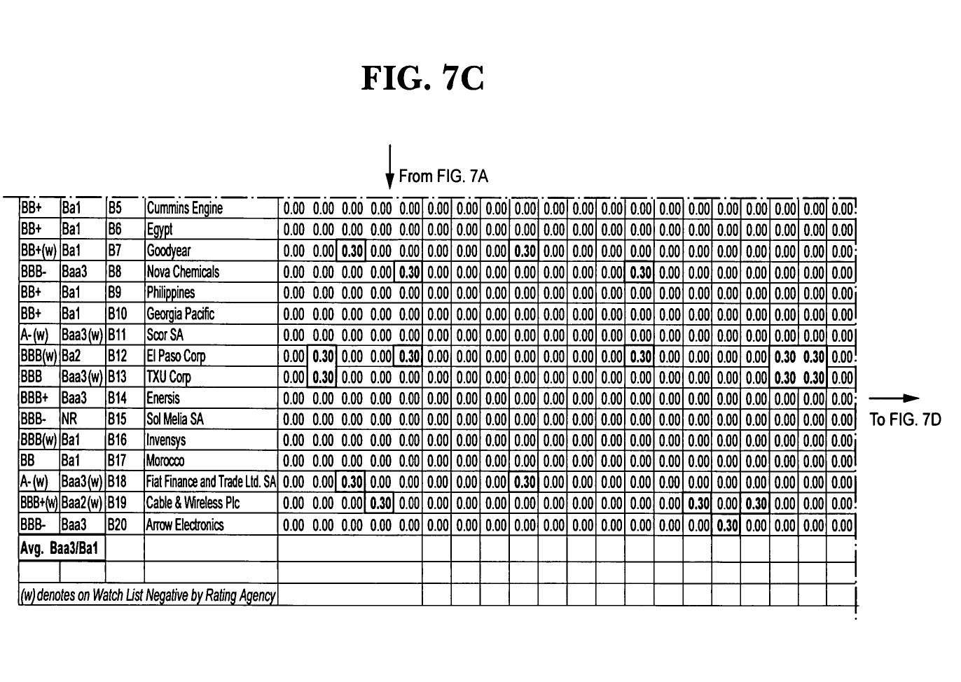

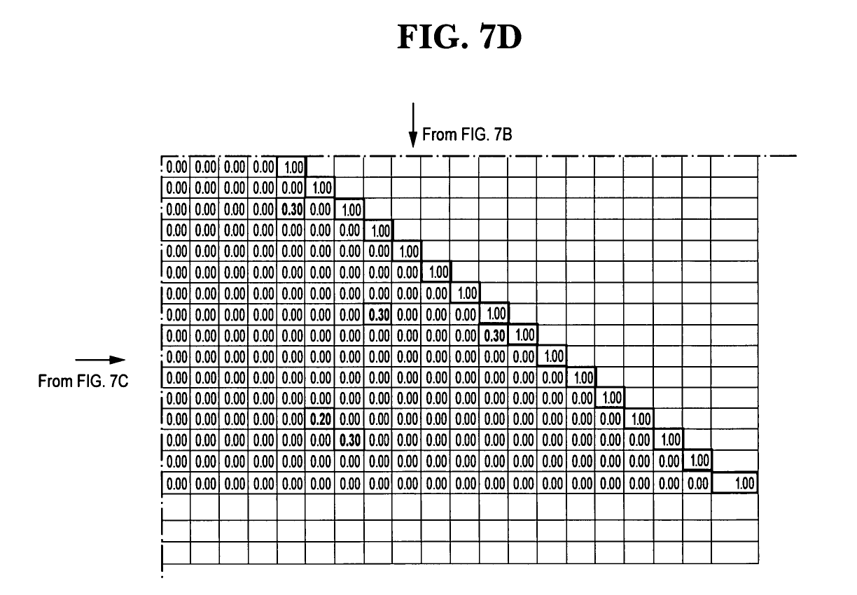

When pairing the reference obligors in the portfolio of FIGS. 4 and 5, the asset and/or default correlations are analyzed in order to assure that the underlying reference obligors in each swap are uncorrelated or substantially uncorrelated. Asset correlation corresponds to an indirect interrelation between firms arising from the dependence of firms' asset values on common macro-economic factors. Ratings agencies, investment banks, and software companies such as KMV and CreditMetrics have methods for estimating this. Default correlation is dependent on firms' default thresholds and asset correlation. Two firms with mildly correlated assets will intuitively have low default correlation since not only do the assets have to move in a correlated fashion, but each firm's assets have to cross its default threshold in a correlated fashion. A simulation on crossing default thresholds over five years was performed. The simulation included evolution of the forty reference obligors' assets via a multivariate standard normal distribution with a correlation matrix. The threshold dependence structure was separated from its marginal behavior by using an inverse normal copula function. The time to default and individual annual default intensity was simulated from this information. The simulation used the default intensities implied by S&P's idealized cumulative default tables. FIG. 6 shows the correlation assumption standards used in the simulation, which are based on S&P asset correlation assumptions. FIG. 7 shows the initial correlation assumptions for the forty reference obligors in the sample portfolio. Pairings were selected for the sample portfolio such that they had a zero correlation in the chart of FIG. 7. A more detailed explanation of the simulation model used in accordance with the instant invention is provided below.

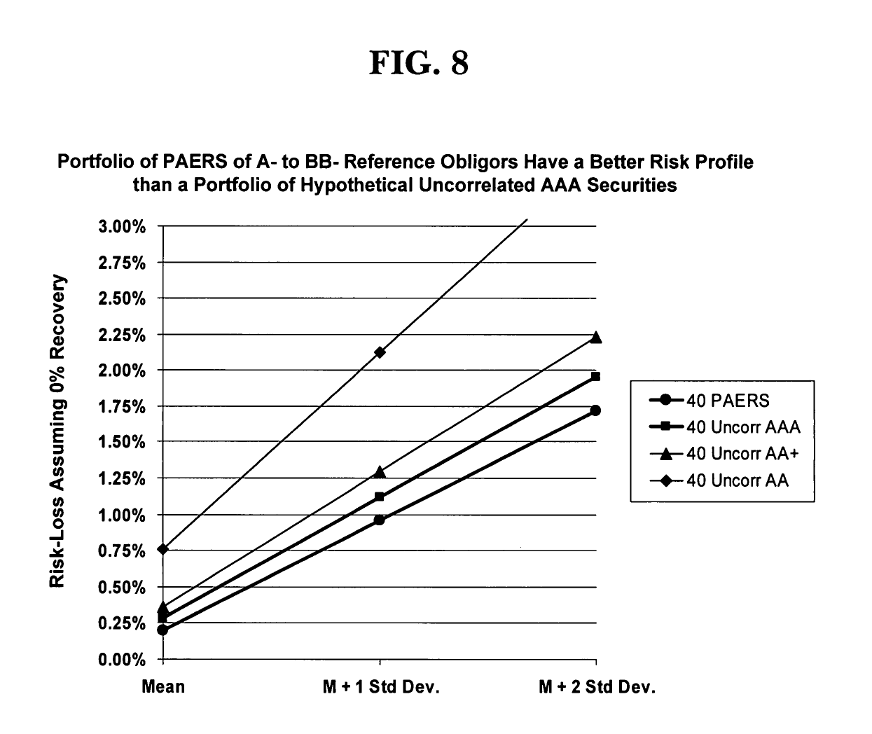

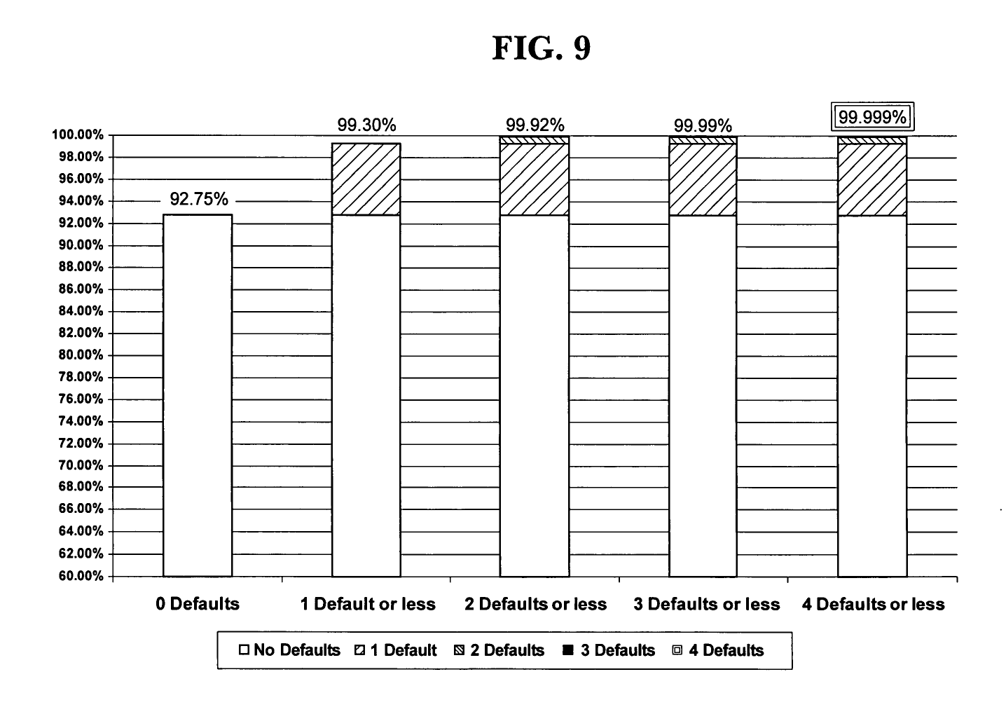

FIG. 8 illustrates an important advantage provided by the instant invention. Specifically, as can be seen in FIG. 8, the sample PAERS portfolio of A− to BB− reference obligors have a better risk profile than a portfolio of hypothetical uncorrelated AAA securities. FIG. 8 shows a comparison between the mean, mean+1 standard deviation and mean+2 standard deviations for forty sample PAERS, forty hypothetical uncorrelated AAA securities, forty hypothetical uncorrelated AA+ securities and forty hypothetical uncorrelated AA securities. The sample PAERS portfolio has a better risk profile than all three of the hypothetical portfolios of traditional uncorrelated AAA, AA+ and AA securities. Thus, in accordance with the invention, new securities can be created and customized to have better risk profiles than other types of available securities. By combining lower rated securities in the manner described herein, new hybrid securities having better risk profiles and higher ratings can be created. FIG. 9 shows the cumulative default probabilities for the sample PAERS portfolio.

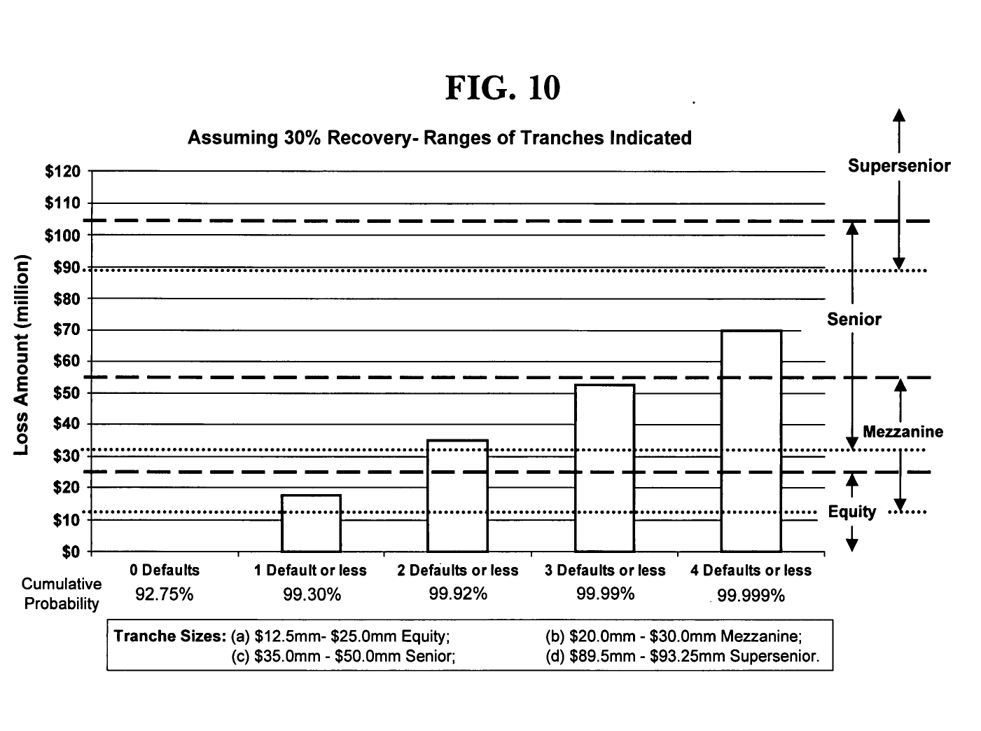

As shown in FIG. 9, the simulation on the sample portfolio indicates that the default probability for zero defaults is 92.75%, 1 default or less is 99.30%, 2 defaults or less is 99.92%, three defaults or less 99.99% and 4 defaults or less is 99.999%. FIG. 10 shows the loss incidence distribution for the PAERS issuer in the PAERS CDO structure described above, having the earlier described ranges for the supersenior, senior, mezzanine and equity tranches. The loss incidence distribution assumes a 30% recovery. Using this simulation and information, the potential investors can analyze the risk profile in order to help determine whether or not they desire to invest in the CDO. The CDO structure and tranche sizes can vary, and the invention is not limited to the specific structure or details described in connection with this sample portfolio or sample CDO structure.

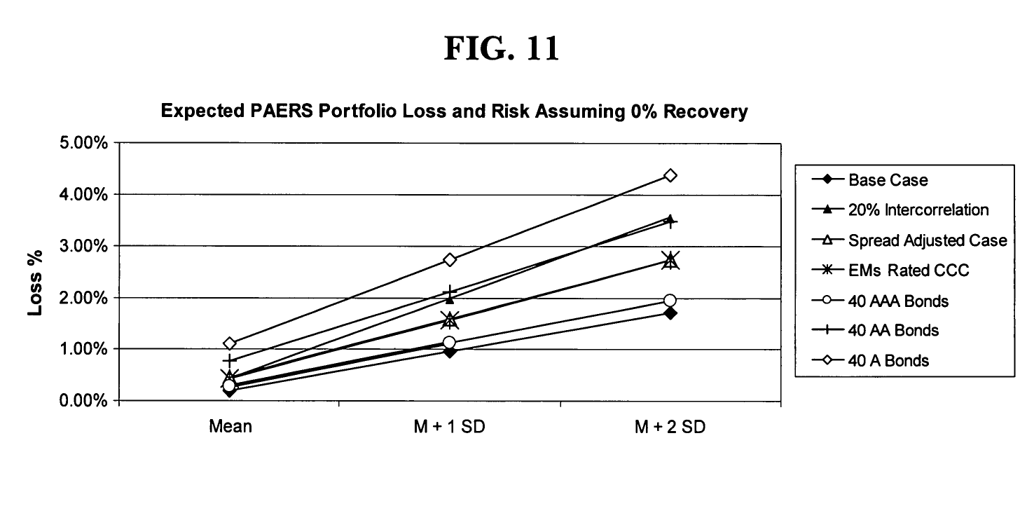

Sensitivity analysis has been performed on the sample portfolio and using the correlation assumptions and rating-derived default probabilities described above. For this analysis, any reference obligor on down grade watch was dropped one notch in rating (base case). Different sensitivity cases were run using the same PAERS portfolio. The first case, referred to as “20% Intercorrelation,” assumed that for the entire 5 year period, there was a 20% correlation between all reference obligors for which the base case assumed less than 20% correlation. The second case, referred to as “Ratings Adjustment,” assumed the eight highest yielding reference obligors dropped two ratings notches for purposes of inputting their default probabilities (those already dropped one notch due to being on downgrade watch were dropped two notches in total). The third case, referred to as “EMs Rated CCC,” assumed all emerging market reference obligors to be rated CCC (i.e., 41.1% default probability). The forth case, referred to as “Spread Adjusted Ratings,” assumed all ratings of reference obligors are adjusted, based on their spread, to a ratings level commensurate with that spread for the broader universe of currently traded credit default swaps. FIG. 11 shows the results of this sensitivity analysis and illustrates the expected PAERS portfolio loss and risk assuming 0% recovery.

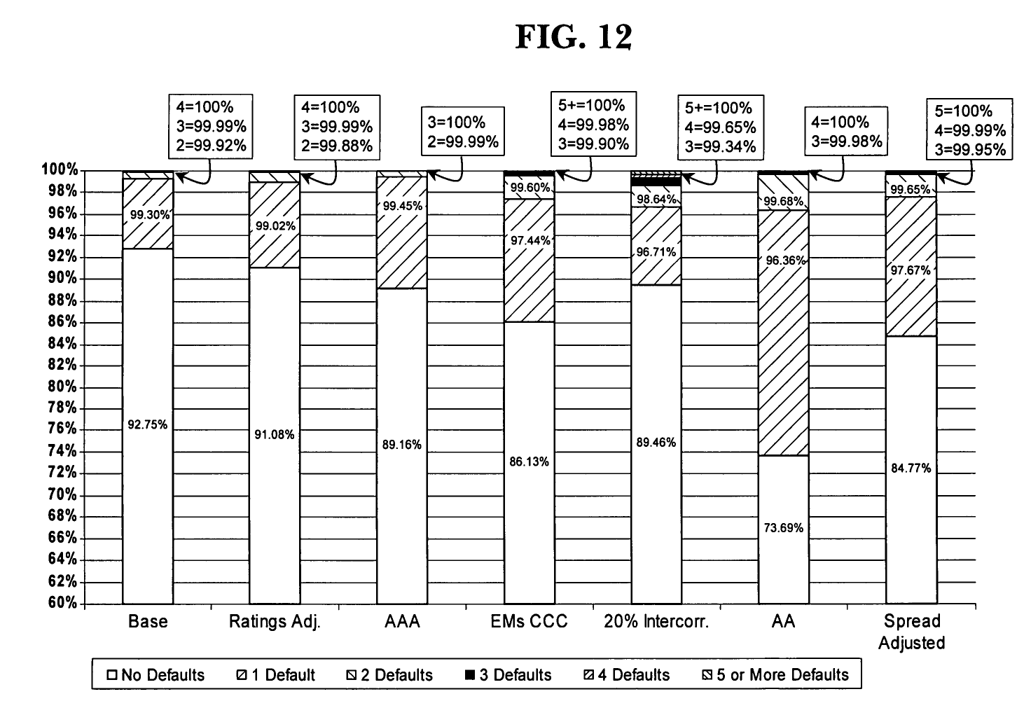

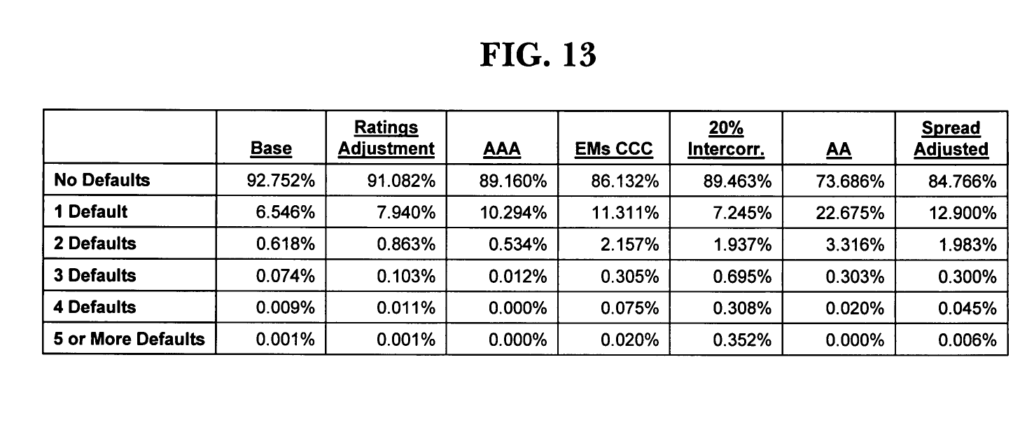

FIG. 11 also illustrates the significant protection provided for the PAERS senior investor. Specifically, in an example CDO structure with $40 million PAERS equity/mezzanine tranches, assuming 0% recovery on the 2^{nd}-to-default reference obligors, the PAERS senior investor suffers no loss at mean+2 standard deviations or higher in all cases. Assuming 30% recovery, the PAERS senior investor suffers no loss at mean+4.5 standard deviations of higher in all cases (other than the 20% correlation case, in which there is no loss at mean+3.3 standard deviations). FIG. 12 shows the cumulative default probabilities for all of the cases. FIG. 13 summarizes the results of the sensitivity analysis in table form. The sensitivity analysis further demonstrates the advantages provided by joint default protection of PAERS and the PAERS CDO structure, in accordance with the instant invention.

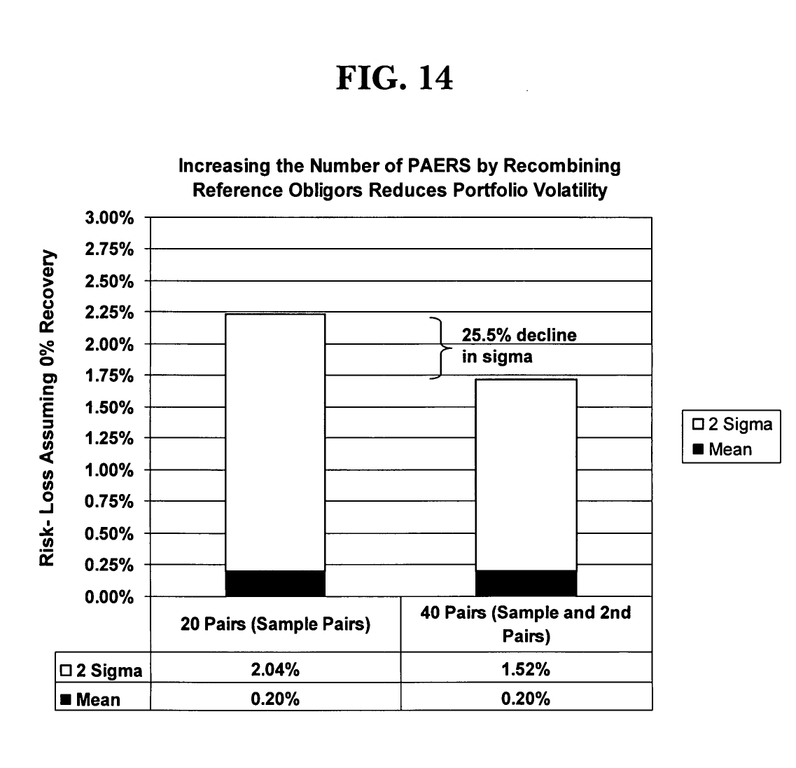

As indicated above, it has been found that additional benefits can be achieved through recombinancy in the PAERS portfolio. Specifically, repeating individual names in different pairings in a PAERS portfolio of constant size reduces overall risk. Increasing the number of PAERS with the total notional deal size constant reduces the standard deviation of default risk due to enhanced diversification. Thus, it has also been found that recombining underlying reference obligors in different 2nd-to-default pairs substantially reduces the standard deviation of default. As long as each pair has low intra-pair correlation, duplication of a reference obligor with a different counterpart reference obligor is similar to adding to a bond portfolio another credit in the same industry to achieve diversification. FIG. 14 illustrates the benefits of recombinancy in the PAERS portfolio. As seen in FIG. 14, increasing the number of PAERS by recombining reference obligors reduced portfolio volatility. For example, using the combined set of 40 pairs from FIGS. 4 and 5 results in a 25.5% decline in standard deviation relative to a portfolio including only the first pairings of FIG. 4. Thus, the preferred embodiment of the invention uses recombinancy to further reduce overall risk.

Once a PAERS portfolio is constructed by, for example, working with a swap counterparty to build the portfolio of underlying swaps, a structure for an overall transaction can be implemented and the various required/desired elements are assembled. This includes, in an exemplary CDO embodiment, modeling the PAERS portfolio to demonstrate the credit profile of the PAERS, arranging any third party financial guarantee or PAERS swap holder, sourcing any potential additional PAERS equity provider, and obtaining debt ratings for the PAERS equity and the underlying PAERS portfolio, if applicable. PAERS Equity is preferably issued in the form of trust certificates or notes and provide investors with a leveraged exposure to a static portfolio of second-to-default positions. The second-to-default positions are provided through a series of credit default swaps (the “swaps”) entered into between the PAERS issuer (CDO vehicle) and swap counterparty. The PAERS equity will pay a coupon (e.g., quarterly) equal to LIBOR on the outstanding principal, plus a spread. PAERS Equity is redeemable at par upon maturity. Partial early redemption will only occur upon a “basket credit event” in an underlying Swap in the portfolio (described further below). Upon any such early redemption, interest and full principal upon maturity will continue to be paid on the remaining PAERS Equity principal balance. In this example, the principal amount of PAERS equity is $50 million. The total notional amount of the underlying portfolio is $1 billion. The entire principal is payable at maturity absent a basket credit event in an underlying Swap. Upon a basket credit event in an underlying swap: coupon payments will cease on $25 million of PAERS equity principal; $25 million of PAERS equity principal will be redeemed in exchange for the cash equivalent received by the PAERS issuer from the swap counterparty; coupon will continue to be paid on the remaining PAERS equity principal; and the remaining PAERS equity principal will be payable in full at maturity. Of course the particular CDO structure and details of the transaction can change and the invention is not limited to the exemplary structure or details described herein.

As indicated above, the portfolio of 40 swaps have the following exemplary characteristics: each swap has a notional principal of $25 million; each swap will have two underlying reference obligors; pursuant to each swap, and the PAERS issuer will receive a premium of X bps on the notional principal until maturity. A credit event of either of the reference obligors will not have any impact on the swap. The swap counterparty will continue to pay the premium to the PAERS issuer. The “credit event” can be any defined condition set forth in the swap agreement. Thus, as indicated above, the invention is not limited to the use of only classic “defaults” as that term is used in the industry. Only a credit event (e.g., default) of both reference obligors results in a “basket credit event” for an individual swap. Upon a basket credit event: premium payments on the individual swap will cease; the swap counterparty will deliver a “deliverable obligation” of the 2nd-to-default reference obligor (or “cash equivalent”) to the PAERS issuer; and the PAERS issuer will deliver $25 million to swap counterparty.

In the preferred embodiment, the senior position in the PAERS portfolio is created synthetically. The senior position purchaser (the “PAERS swap holder”) will enter into a credit default swap (the “PAERS swap”) with the swap counterparty with a notional principal, in this example, of $950 million. The swap counterparty pay Y bps premium on the notional principal amount. The PAERS swap will reference the 40 pairs of reference obligors referenced in the swaps with the PAERS issuer. Upon either a credit event of a reference obligor or the first 2 basket credit events (in this example), the PAERS swap will be unaffected. Upon the 3^{rd} and each subsequent basket credit event: premium payments to the PAERS swap holder will cease on $25 million notional principal for each such basket credit event; the PAERS swap holder will receive a deliverable obligation or cash equivalent of the 2nd-to-default reference obligor; and the PAERS swap holder will pay to the swap counterparty $25 million. The notional principal amount of the PAERS swap will be reduced by $25 million.

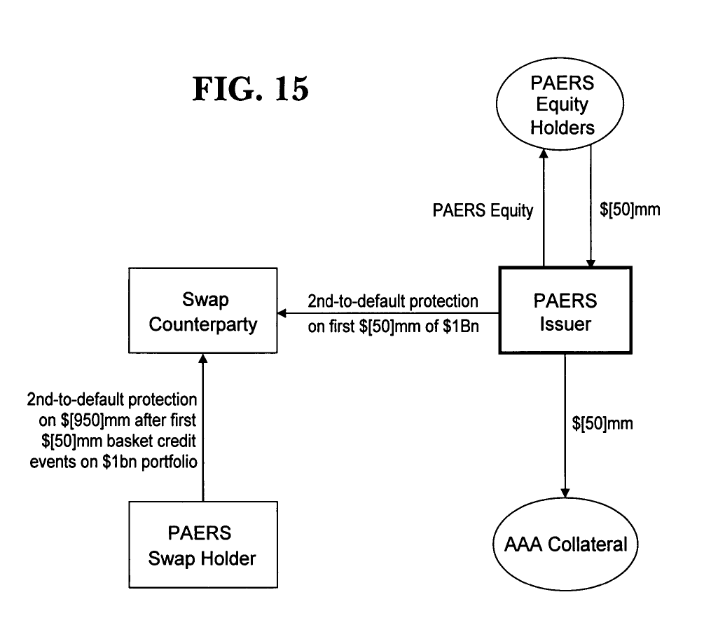

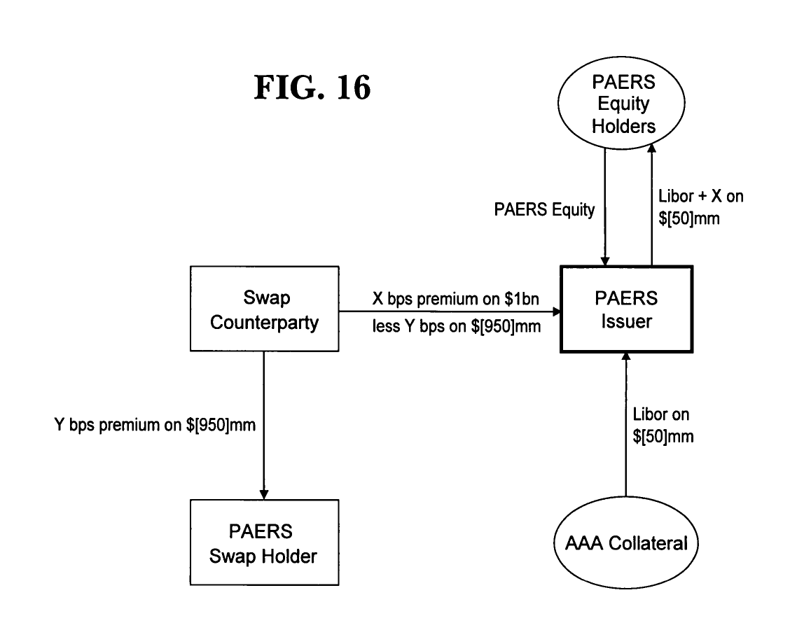

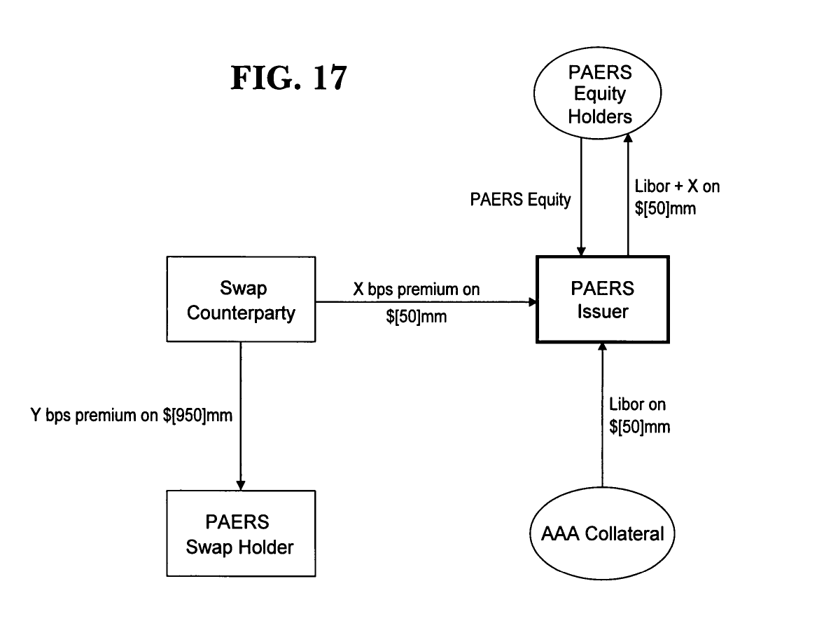

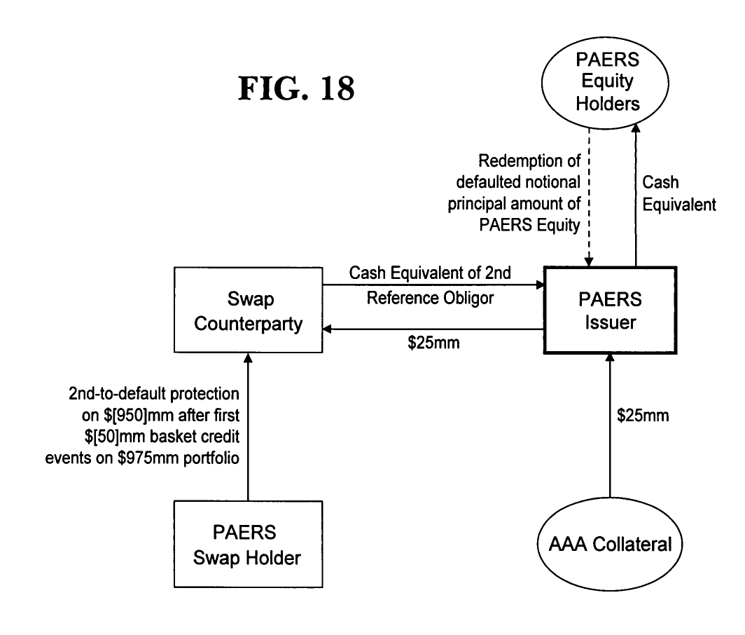

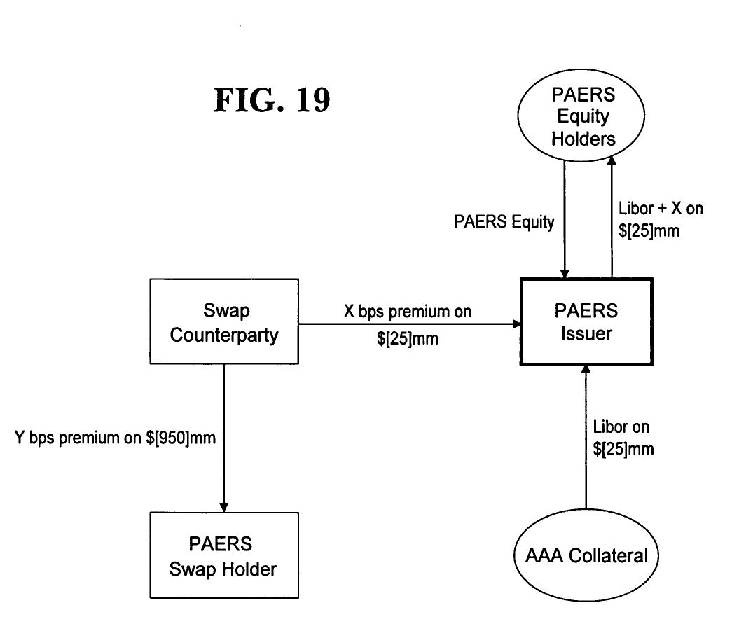

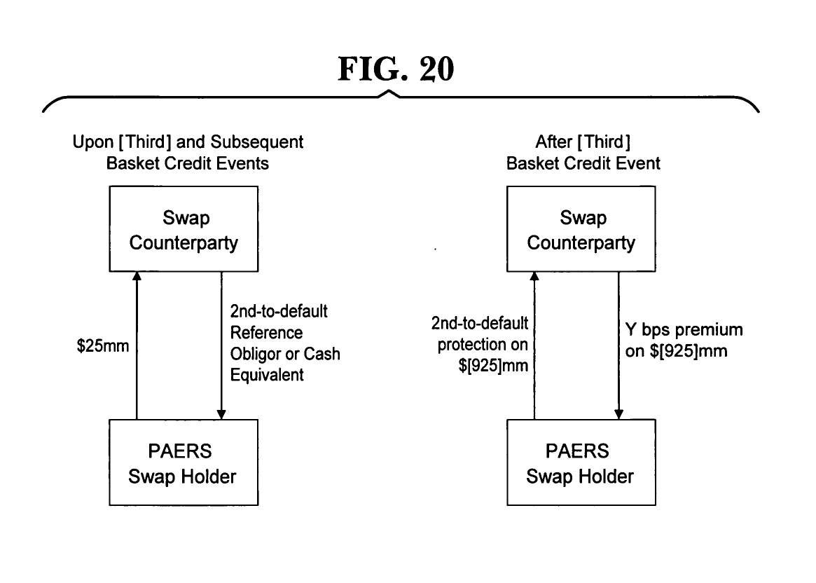

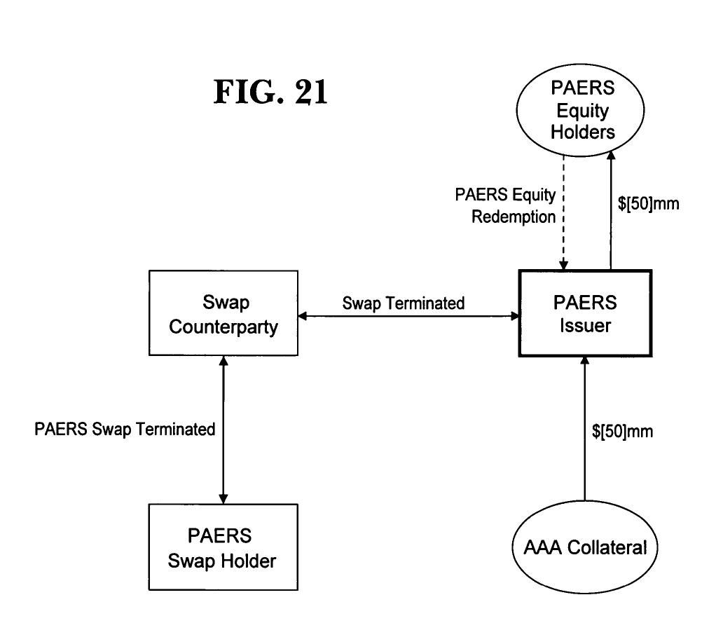

This exemplary transaction is illustrated in FIGS. 15-21. Specifically, FIG. 15 is a structure diagram of an exemplary PAERS investment and illustrating issuance of PAERS equity. FIG. 16 is a structure diagram illustrating the ongoing cash flow in the PAERS investment shown in FIG. 15. FIG. 17 is a structure diagram illustrating the impact on the PAERS investment of FIG. 15 after the first default of a reference obligor. FIG. 18 is a structure diagram illustrating the impact on the PAERS investment upon a first basket credit event. FIG. 19 is a structure diagram illustrating the PAERS investment after the first basket credit event. FIG. 20 shows structure diagrams illustrating the impact on the PAERS investment upon the third basket credit event and the flows after the third basket credit event. Finally, FIG. 21 shows a structure diagram illustrating the PAERS investment of FIG. 15 at maturity with no defaults or basket credit events.

It is noted that the example of FIGS. 15-21 only includes equity and supersenior tranches, with equity being funded and supersenior being synthetic. However, additional tranches can be used, such as senior and mezzanine tranches discussed above, and the particular funding and deal size can vary as well depending on the desires of the parties to a PAERS transaction. It is also noted that, in this example, the senior swap provider only gets called upon to cover the loss when the third basket credit event occurs. However, in reality, this occurrence is driven by some other factors, including how much in fact is lost upon each basket credit event. This depends on the size of each basket and the actual loss incurred for each basket, which will vary depending on the actual recovery rate for the 2^{nd} defaulting name when it defaults. Another factor is the amount of equity and other junior tranches below the supersenior, which determines how much in total losses gets covered before the supersenior gets called upon to cover. Thus, the example described herein is only illustrative of a sample transaction, and is not intended to limit the invention to the specifics thereof.

The formula used for determining probability is described below. If bond defaults in a portfolio of N bonds are independent and identically distributed, then the probability of exactly k bonds defaulting is given by the binomial formula, where: p=probability that an event will occur; N=total number of possible events (e.g., the number of credits in the basket); and K=number of occurrences required (e.g., if it is 2nd to default then k=2). Then:

$$P ( k out of N ) = \frac{N !}{k ! \times ( N - k ) !} \times {p}^{k} \times {( 1 - p )}^{( N - k )}$$

For example:
For k=N (i.e., if entire basket needs to default), P(k)=p^{k}

In the case of 2nd-of-2, with a p=2.50%, the probability of a basket default is: 0.025²=0.000625=0.0625%
For k=2, N=6, p=2.50%, the probability of a basket default is:
   [6!/(2×4!)]×0.025²×0.975⁴=[30/2]×0.000625×0.903688=0.008472=0.8472%

Further details on the simulation model discussed above will now be described in order to give a more complete understanding thereof. Using S&P's cumulative idealized default table by ratings, the default intensity (dn) is calculated from one year to the next. This is done knowing that the cumulative probabilities (Pn) from one year to the next is defined as Pₙ=P₋₁+dₙ(1−Pₙ₋₁). That is, the cumulative default probability this year is the cumulative default probability of default up to the prior year plus the probability of default (default intensity times no prior defaults) this year. The default intensities are slightly different from year to year. For simplicity and without loss of generality, the intensities are averaged and a constant annual default intensity d is used for each rating level. This is equivalent to the annual default intensity determined using an exponential distribution and the 5 year cumulative default probability. Next, scenarios of asset levels are generated from standard normal variants subject to a correlation matrix, ending up with correlated normalized asset levels. These asset levels are then inverted with a standard normal copula to determine the marginal probabilities of default (P), which are inferred from the resulting asset levels. After that, the time to default is determined from an exponential distribution with the parameter equal to the appropriate default intensity: P=1−e^{-dt}. 65,000 scenarios are then run all the reference obligors, and a check is then made to see if both reference obligors in a pair default before the end of 5 years and, if so, when they default. The simulation generates the distribution, mean and standard deviation of number of basket defaults in a particular year and within the five years, from these 65,000 trials.

A more detailed background to the statistical mechanics and the simulation methodology is now provided. Failure rates of complex components such as electronic equipment, jet engines and power plants are traditionally modeled with an exponential hazard function- i.e., probability of failure=1−e^{-xt}. In this formula, t=time, and x can be thought of as the variable that describes the lack of quality. Recently, the failure rate of obligors (i.e., default rates) have been similarly modeled with the exponential probability distribution. In the case of a bond, we can use this formula to determine the annual default probability (d) given the 5 year cumulative default probability (i.e., the failure rate of the bond (P)) from S&P's idealized cumulative default probability table. So, for a BB− bond, where P=0.130 (i.e., there is a 13.0% cumulative probability that the bond will default in 5 years) we can solve for d as follows:

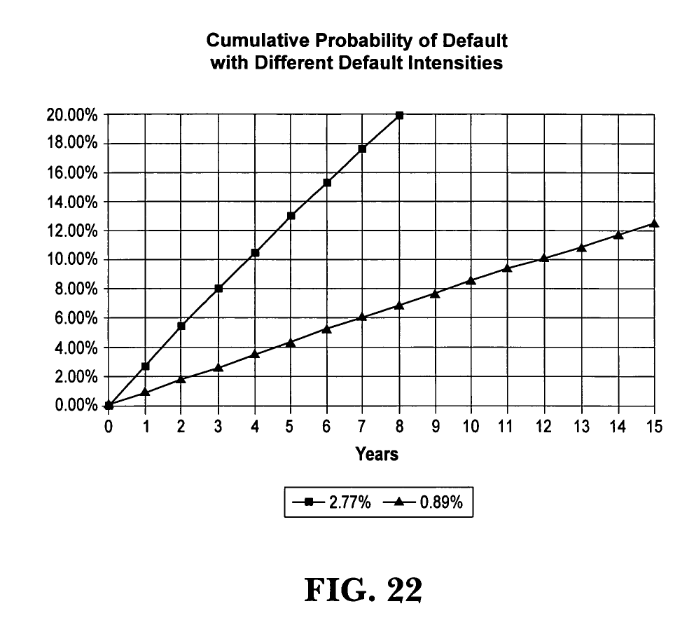

0.130=1−e^{-d5}. In this case, d=0.0279 (expressed as 2.79%). Similarly, for a BBB− bond, for which P=4.39%, the annual default probability will be 0.90% (or 0.0090). FIG. 22 graphs the annual and cumulative default probabilities of a BB− and BBB− bond over time. Note, that for any given probability of default (i.e., a number between 0 and 1), we can determine a time to default. For a higher quality bond, the same probability would imply a longer time to default than for a lower quality bond (e.g., for P=0.1, time to default is 12 years for a BBB− bond and just under 4 years for a BB− bond).

For each trial run of the simulation model, the simulator would generate a random number to represent cumulative probability of default (i.e., failure) between 0 and 1, with those numbers uniformly distributed over all the trials. Thus, the mean random number would be 0.5. For each random number generated for a trial, time to default can be calculated using the exponential distribution and known annual default intensity. So, for example, if d=0.0279, and the random number is 0.5, the time to default (t) will be 25 years. Conversely, with d=0.0279, for randomly generated P's≦0.130, t will be ≦5 and the bond would default in ≦5 years. Since the random numbers are uniformly distributed between 0 and 1, P's≦0.130 will occur 13.0% of the time. Thus, the trial runs of the simulator would indicate a default of the bond within the 5 year time period 13.0% of the time, matching the S&P default table that was used to generate the annual default intensity of 0.0279.

If the value of each asset in the future can be represented by a normal distribution, the distribution of future asset values on a graph with y-axis for number of times the value appears and x-axis for the value would be a normal bell curve. The peak value of the bell curve would be exactly in the middle of the curve, representing the mean. Because of the symmetrical distribution, 50% of the outcomes would occur to the left and 50% to the right (so that the mean is also the median). A normal bell curve can be represented as having 0 as its mean, with −infinity and +infinity at the two tails. In that case, 50% of the outcomes will be below zero and 50% above zero. In addition, 68% of the cases will be between −1 and +1 (i.e., within 1 standard deviation of the mean) and 95% of the cases will be between −2 and +2 (i.e., within 2 standard deviations). Consequently, 16% of the cases will be below −1, and 2.5% of the cases below −2.

The joint outcome of two asset values can be represented on a graph where the x-axis represents the value of one asset and the y-axis represents the value of the other asset. Thus, for each trial, a joint value (or x, y coordinate on the graph) could be determined. The more times a particular outcome occurs, the darker that particular point (or area) on the graph would be.

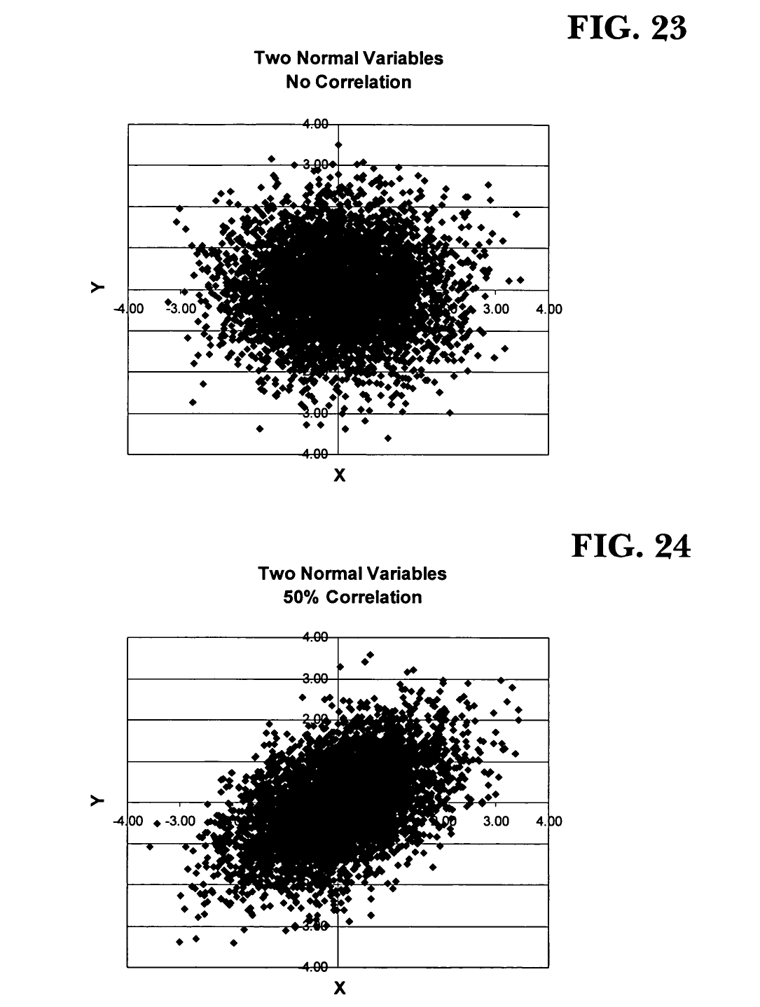

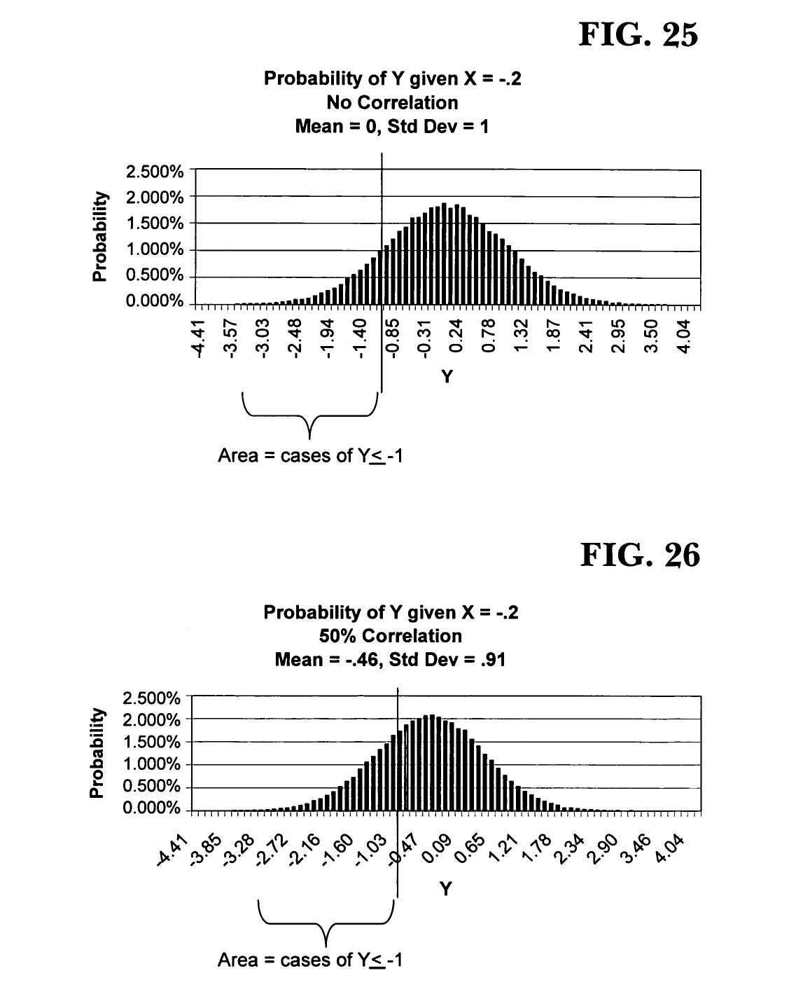

If two assets are entirely independent of each other (i.e., their correlation is zero), then the distribution of joint outcomes on a two dimensional graph would appear as a “perfect” disk. The center of the disk would be darkest (i.e., representing the fact that the highest number of joint outcomes occur for the cases that represent the most likely outcome for each asset individually (the mean, as described above under Normal distribution)). (see FIG. 23). As the correlation of two assets increases from zero, the distribution of the joint outcomes moves away from a perfect disk to a more elongated disk. The disk gets “squeezed” on the two sides at a 45° angle to the x and y axes (see FIG. 24). This occurs, because if one asset is farther from the mean, the other asset has a greater than normal likelihood of also being farther from the mean. In other words, because the assets are somewhat correlated, the fact that one asset is “negative” means that the other one is also more likely to be negative than an independent (i.e., uncorrelated) asset would be. Another way to think of partial correlation is that the fact that one asset (say X) is negative, means that the distribution of outcomes for the other asset (Y) will be somewhat shifted toward the negative. If Y is otherwise normally distributed, that will mean that given the negative value for X, there are more cases of Y that are negative than there would be if X had been exactly at the mean (see FIGS. 25 and 26). In the most extreme case of perfect correlation (i.e., correlation=1), the disk becomes a 45° line, with the middle of the line being darkest. So, whatever value is generated for X, will also be the value for Y.

In the case of either zero or 1 correlation, it is not necessary to simulate the joint outcomes. Instead, the simulation for single bond defaults could be used with each bond outcome simulated independently of the other for those with zero correlation. Any bonds that are fully correlated with another do not need to be separately simulated since their outcome will be exactly the same as the bond with which they are fully correlated. In the case of PAERS, there are reference obligors that have a non-zero and non-unitary correlation. Thus, a simulation of joint outcomes is necessary. In order to do so, the simulation model assumes that the future asset values for any asset are normally distributed, absent their correlation to other assets. It then takes into account the correlation between each possible pair of assets when generating a joint outcome of asset values for each trial. Because there are 40 underlying Reference Obligors, there are 780 (i.e., (40*39)/2) possible pairings whose correlation must be accounted for in simulating asset outcomes. If the joint outcomes of a given pair of bonds from the 65,000 trials were to be plotted, then the distribution would generate a graph similar to those described above. The amount that the distribution varies from a uniform disk will depend on the correlation of the given pair.

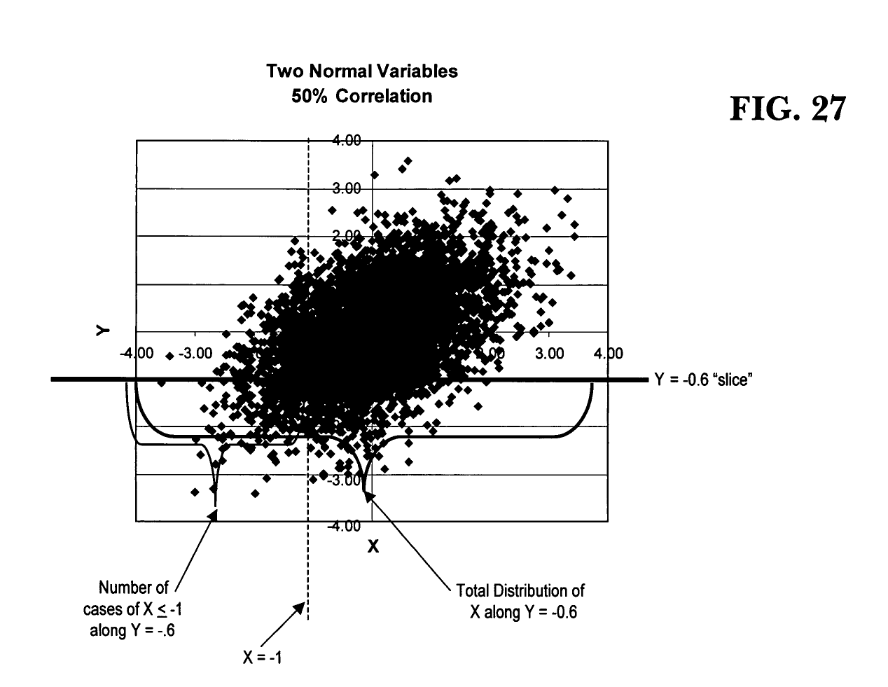

In order to convert the asset outcomes into default probability, the model must take the asset values and convert to a probability. This can be accomplished through use of a copula function. Mathematically, the copula function calculates the marginal asset level distribution for one asset given the value generated for the other asset. Thus, given a value for X, the copula function determines how Y is distributed. Based on that determination, the function can then calculate the probability (P) represented by the asset value generated for Y. The copula function can be thought of as taking a slice of the disk at the indicated asset value for the particular asset, with the slice running along all possible values for the other asset. The function can then determine the probability of any given asset value for the other asset. For example, assume in one of the trials that the simulator generates (−1,−0.6) for (X,Y). Given an assumed correlation of X and Y (and assuming they are otherwise normally distributed), the total distribution of X,Y outcomes would be an elongated disk as in FIG. 24. To determine what probability a value of X=−1 represents given that Y=−0.6, the copula function “slices” the graph horizontally at Y=−0.6. It then “counts” the number of outcomes of X≦−1 along that slice and compares that to the total number of outcomes along that slice. (See FIG. 27). That percentage is the implied cumulative probability of default for X=−1, given that Y=−0.6.

The percentage determined by the copula function is then converted to a time to default using the exponential distribution described above. For the actual simulations, as noted above, the model needs to account for all 780 pair-wise correlations. In addition, the copula function needs to similarly take into account all 39 other asset outcomes in determining the distribution of the asset whose probability is being determined for purposes of calculating time to default.

As explained above, the instant invention is directed to individual hybrid securities having a last to default condition for the underlying uncorrelated or substantially uncorrelated reference obligors. The invention is also directed to a portfolio of such hybrid securities as described above. The invention further covers a structured transaction wherein a PAERS portfolio (having one or more PAERS securities therein) is the subject of a CDO or other structured investment transaction.

In addition to the bond/securities embodiments described above, the PAERS technology has application to any situation in which someone is taking credit risk, where that risk is referenced to any obligor or obligors, either directly or indirectly. Essentially, the instant invention enables either debtors or creditors to lower the credit risk of an obligation by combining obligors. Fundamentally, two ways to utilize the instant invention are: (1) by having separate obligors issue a joint and several obligation; or (2) combining separate obligations such that a creditor seeking protection against event risk is only exposed to the ith (e.g., 2nd) to default of i (e.g., 2) obligations.

Examples of these additional applications of the instant invention to certain sectors include, but are not limited to:

A) Insurance Contracts or Products: A Guaranteed Investment Contract (GIC), funding agreement or financial guaranty policy or surety contract is combined with any other combination of insurance contracts or products, including for example, by having two insurance companies issue joint and several GICs (or similar obligations);

B) Sovereign Debt Issuance: A country is obligated jointly and severally in a co-issuance of debt or debt-like obligations with another obligor of any type, but preferably with another country, where the co-issuances may be defined broadly as originating in the new issue or secondary markets, or as a hybrid;

C) Corporate Debt Issuance: A corporation is obligated jointly and severally in a co-issuance of debt or debt-like obligations with another obligor of any type, but preferably with another corporation, where the co-issuances may be defined broadly as originating in the new issue or secondary markets, or as a hybrid, or when the issuance involves a restructuring;

D) Leasing Structures: The credit exposure in different leases is combined;

E) Asset Backed Securities (ABS): Finance vehicles that reference either singly or in combinations any ABS class including but not limited to credit cards, equipment trusts, real estate, autos and manufactured housing;

F) Project Finance: The credit exposure in different projects is combined;

G) Public Finance: Obligations such as municipal bonds backed by revenue from publicly financed projects including but not limited to airports, bridges and hospitals, or by the general obligations of municipal, state governmental, quasi governmental and other governmental entities or by any combination thereof or in combination with any other type of obligor; and

H) Portfolio Optimization Strategies: Including the PAERS invention in a portfolio can be used to enhance existing portfolios.

While the preferred embodiments of the invention have been illustrated and described, it will be apparent to those skilled in the art that various changes and modifications may be made without departing from the true scope and spirit of the invention. Thus, the description herein is meant to be exemplary only and is not intended to limit the invention to the specific embodiments described.

1. A hybrid security having protection against event risk, said hybrid security comprising:
a first reference obligor; and
a second reference obligor, wherein said first and second reference obligors are uncorrelated and define a two-name basket;
said hybrid security having a default condition that requires both said first reference obligor and said second reference obligor to experience a defined credit event, thereby constituting a second-to-default credit default swap over said two-name basket.

2. The hybrid security of claim 1, wherein said first reference obligor and said second reference obligor are uncorrelated relative to assets.

3. The hybrid security of claim 1, wherein said first reference obligor and said second reference obligor are uncorrelated relative to defaults.

4. A hybrid security having protection against event risk, said hybrid security comprising:
I reference obligors, wherein I is at least three and each of said reference obligors are uncorrelated and define a I-name basket;
said hybrid security having a default condition that requires all I reference obligors to experience a defined credit event, thereby constituting a last-to-default credit default swap over said I-name basket.

5. The hybrid security of claim 4, wherein said I reference obligors are uncorrelated relative to assets.

6. The hybrid security of claim 4, wherein said I reference obligor are uncorrelated relative to defaults.

7. A hybrid security having protection against event risk, said hybrid security comprising:
a first reference obligor; and
a second reference obligor, wherein said first and second reference obligors are at least substantially uncorrelated and define a two-name basket;
said hybrid security having a default condition that requires both said first reference obligor and said second reference obligor to experience a defined credit event, thereby constituting a second-to-default credit default swap over said two-name basket.

8. The hybrid security of claim 7, wherein said first reference obligor and said second reference obligor are at least substantially uncorrelated relative to assets.

9. The hybrid security of claim 7, wherein said first reference obligor and said second reference obligor are at least substantially uncorrelated relative to defaults.

10. A hybrid security having protection against event risk, said hybrid security comprising:
I reference obligors, wherein I is at least three and each of said reference obligors are at least substantially uncorrelated and define a I-name basket;
said hybrid security having a default condition that requires all I reference obligors to experience a defined credit event, thereby constituting a last-to-default credit default swap over said I-name basket.

11. The hybrid security of claim 10, wherein said I reference obligors are at least substantially uncorrelated relative to assets.

12. The hybrid security of claim 10, wherein said I reference obligor are at least substantially uncorrelated relative to defaults.

13. A portfolio of hybrid securities having protection against event risk, said portfolio comprising:
a collection of hybrid securities, wherein each hybrid security includes;
i. a first reference obligor; and
ii. a second reference obligor, wherein said first and second reference obligors are uncorrelated or substantially uncorrelated and define a two-name basket;
each of said hybrid securities having a default condition that requires both said first reference obligor and said second reference obligor to experience a defined credit event, thereby constituting a second-to-default credit default swap over said two-name basket.

14. The portfolio of claim 13, wherein said first and second reference obligors in each hybrid security are selected from a defined list of underlying reference obligors, and said collection of hybrid securities includes various unique combinations of reference obligors from said defined list.

15. The portfolio of claim 14, wherein at least some of the underlying reference obligors are included in more than one unique two-name basket in order to further reduce default risk through enhanced diversification.

16. A portfolio of hybrid securities having protection against event risk, said portfolio comprising:
a collection of hybrid securities, wherein each hybrid security includes;
i. I reference obligors, wherein I is at least three and each of said reference obligors are at least substantially uncorrelated and define a I-name basket;
each of said hybrid securities having a default condition that requires all I reference obligors to experience a defined credit event, thereby constituting a Ith-to-default credit default swap over said I-name basket.

17. The portfolio of claim 16, wherein said I obligors in each hybrid security are selected from a defined list of underlying reference obligors, and said collection of hybrid securities includes various unique combinations of reference obligors from said defined list.

18. The portfolio of claim 17, wherein at least some of the underlying reference obligors are included in more than one unique I-name basket in order to further reduce default risk through enhanced diversification.

19. A structured investment, comprising a collateralized debt obligation structure (CDO) in which the portfolio of hybrid securities defined in claim 13 constitutes the asset class in the CDO.

20. A structured investment, comprising a collateralized debt obligation structure (CDO) in which the portfolio of hybrid securities defined in claim 16 constitutes the asset class in the CDO.
